(19) United States
(12) Patent Application Publication
(10) Pub. No.: US 2011/0177847 A1
(43) Pub. Date: Jul. 21, 2011

(54) Power-saving Method for Mobile Communication Device

(76) Inventor: Chien-Jen Huang, Taoyuan County (TW)

(21) Appl. No.: 13/008,026

(22) Filed: Jan. 18, 2011

Related U.S. Application Data
(60) Provisional application No. 61/295,771, filed on Jan. 18, 2010.

(51) Int. Cl. H04W 52/02; H04W 88/02

(52) U.S. Cl. 455/574

(57) ABSTRACT

A power-saving method for a mobile communication device includes periodically stopping the mobile communication device transmitting data by a first ratio for a first predetermined time, and periodically stopping the mobile communication device transmitting data by a second ratio after the first predetermined time; wherein the first and the second ratios represent a period of stopping data transmitting and a period of executing data transmitting, and the second ratio is higher than the first ratio.

### CROSS REFERENCE TO RELATED APPLICATIONS

This application claims the benefit of U.S. Provisional Application No. 61/295,771, filed on Jan. 18, 2010, and entitled “Discontinuous packet transceiving in a mobile IP network”, the contents of which are incorporated herein in their entirety.

### BACKGROUND OF THE INVENTION

1. Field of the Invention

The present invention relates to a power-saving method for a mobile communication device, and more particularly, to a method for saving power of a mobile communication device by periodically disabling transmitting/receiving functions of the mobile communication device.

2. Description of the Prior Art

Mobile communication devices, e.g. cellular phones, play an essential part in everyone's life nowadays. Generally, the mobile communication devices allow users to dial telephone or accessing the internet. In this way, the user can call friends, receive e-mails, check facebook updates, etc. In the prior art, the mobile communication devices execute the above services by continuous transmission. That is, components related to the above services are continuously operating to receive/transmit calls or access the internet.

Since the battery capacity of the mobile communication device is very limited, manufacturers are all devoted to reduce power consumption of the mobile communication device to extend the use-time. In the prior art, the mobile communication device enters a standby mode when the user does not use the mobile communication device over a predetermined time. In the standby mode, a display screen of the mobile communication device is turned off to save power, and other components, especially those for phone call and internet accessing, are still continuously operating.

However, even though power is saved in the standby mode by turning off the screen, the components for phone call and accessing the internet are still continuously operating, which still consumes power as in the normal mode, so that the standby mode of the prior art does not effectively save power of the mobile communication device.

### SUMMARY OF THE INVENTION

The present invention provides a power-saving method for a mobile communication device. The power-saving method comprises executing discontinuous data transmission when the mobile communication device enters a standby mode.

The present invention further provides a power-saving method for a mobile communication device. The power-saving method comprises executing discontinuous data reception when the mobile communication device enters a standby mode.

The present invention further provides a mobile communication device with power-saving function. The mobile communication device comprises means for executing discontinuous data transmission when the mobile communication device enters a standby mode.

The present invention further provides a mobile communication device with power-saving function. The mobile communication device comprises means for executing discontinuous data reception when the mobile communication device enters a standby mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a schematic diagram of a mobile communication device with a power-saving function according to the present invention.

FIG. 2 is a flowchart illustrating a power-saving process for a mobile communication device in transmission.

FIG. 3 is a flowchart illustrating a power-saving process for a mobile communication device in reception.

### DETAILED DESCRIPTION

The present invention categorizes the transmission/reception of the mobile communication device into two types: real-time transmission/reception (phone call) and non-real-time transmission/reception (accessing the internet). Data transmission/reception is categorized in the non-real-time transmission/reception, so that the data transmission/reception can be discontinuous. In other words, data to be transmitted can be suspended during the discontinuous data transmission/reception. During the suspension, the components related to the transmission/reception can stop operating, which saves power. Therefore, the present invention utilizes discontinuous data transmission/reception to save power of the mobile communication device.

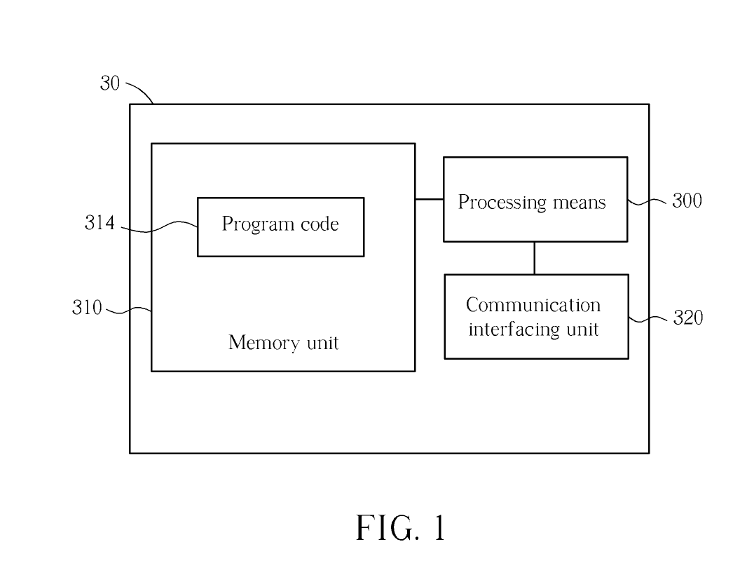

Please refer to FIG. 1, which illustrates a schematic diagram of a mobile communication device 30 with a power-saving function according to the present invention. The mobile communication device 30 may include a processing means 300 such as a microprocessor or ASIC (Application-Specific Integrated Circuit), a memory unit 310 and a communication interfacing unit 320. The memory unit 310 may be any data storage device that can store program code 314 for access by the processing means 300. Examples of the memory unit 310 include but are not limited to a subscriber identity module (SIM), read-only memory (ROM), random-access memory (RAM), CD-ROMs, magnetic tapes, hard disks, and optical data storage devices. The communication interfacing unit 320 may be preferably a radio transceiver and accordingly exchanges wireless signals with other communication devices according to processing results of the processing means 300.

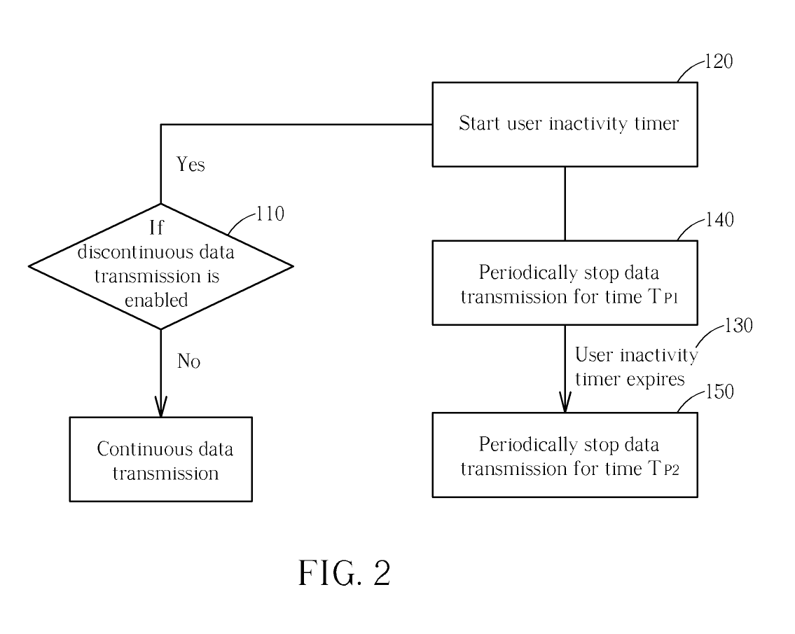

Please refer to FIG. 2. FIG. 2 is a flowchart illustrating a power-saving process 10 for a mobile communication device. The process 10 may be compiled into the program code 314 and include the following steps:

Step 110: Determine if discontinuous data transmission is enabled; if so, go to step 120; if not, execute continuous data transmission.

Step 120: Start a user inactivity timer for entering a shallow sleep mode.

Step 130: When the user inactivity timer expires, enter a deep sleep mode.

Step 140: Periodically stop data transmission for a first predetermined time T_{P1} in the shallow sleep mode.

Step 150: Periodically stop data transmission for a second predetermined time T_{P2} in the deep sleep mode.

Step 160: Resume continuous data transmission when a condition is met.

In Step 110, the user of the mobile communication device can select to enable the discontinuous data transmission by himself/herself, or the discontinuous data transmission can be enabled when the mobile communication device enters a standby mode.

In Step 120, after the discontinuous data transmission is enabled (in the standby mode), the user inactivity timer starts to count the time that the user does not use the mobile communication device and the mobile communication device enters a shallow sleep mode. User activity can be defined as touching the screen, pressing the buttons, or incoming calls. If the user activity does not occur, the user inactivity timer keeps counting. However, if the user activity occurs, the user inactivity timer stops counting and the mobile communication device exits the standby mode.

In the shallow sleep mode (Step 140), the mobile communication device executes the discontinuous data transmission of type A. In type A, the data transmission is periodically stopped for a predetermined time T_{P1}. In other words, a cycle CA is defined in type A. In the cycle CA, the data transmission stops for the time T_{P1}, and the data transmission starts for the rest time of the cycle CA. For example, assuming the user inactivity timer is set to be expired in 5 hours, the cycle CA is set to be 1 hour, and the time T_{P1} is set to be 50 minutes, in the first hour, the data transmission executes for 10 minutes and stops for 50 minutes; in the second hour, the data transmission executes for 10 minutes and stops for 50 minutes; and so on.

In the deep sleep mode (Step 150), after the user inactivity timer expires, the mobile communication device executes the discontinuous data transmission of type B. In type B, the data transmission is periodically stopped for a predetermined time T_{P2}. In other words, a cycle CB is defined in type B. In the cycle CB, the data transmission stops for the time T_{P2}, and the data transmission starts for the rest time of the cycle CB. For example, assuming the user inactivity timer is set to be expired in 5 hours, the cycles CA and CB are set to be 1 hour and 2 hours respectively, and the time T_{P1} and T_{P2} are set to be 50 minutes and 115 minutes respectively, in the first 5 hours, the data transmission executes for 10 minutes and stops for 50 minutes for each hour; after the first 5 hours, the user inactivity timer expires and the mobile communication device enters the deep sleep mode. In the 6^{th} hour to the 8^{th} hour, the data transmission executes for 5 minutes and stops for 115 minutes; in the 9^{th} hour to the 11^{th} hour, the data transmission executes for 5 minutes and stops for 115 minutes; and so on.

In Step 160, the discontinuous data transmission is terminated and the continuous data transmission is resumed when a condition is met. This also means the mobile communication device exits the standby mode. The condition can be, e.g. the occurrence of an incoming call, or a button pressed by the user, or any rules defined by the user.

Besides, the standby mode can be activated by the same user inactivity timer or another timer. If standby mode is activated by the same user inactivity timer, when the mobile communication device is turned on, the user inactivity timer starts to count. If the user inactivity timer counts over a first number, the mobile communication device enters the standby mode. In the standby mode, the discontinuous data transmission of type A is enabled and the mobile communication further enters the shallow sleep mode, and the user inactivity timer keeps counting. If the user inactivity timer counts over a second number (greater than the first number), the mobile communication device enters the deep sleep mode to activate the discontinuous data transmission of type B.

Simply speaking, in the normal mode, the mobile communication device consumes power as normal, but when the user is not active to the mobile communication device (the user inactivity timer counts over a first number), the mobile communication device enters the standby mode. For short periods, e.g. the user taking a nap, the communication device enters the shallow sleep mode to save power. For long periods, e.g. the user going sleeping, the mobile communication device enters the deep sleep mode to save much more power than the shallow sleep mode.

It is to be noted that the difference between the shallow and deep sleep modes is the ratio of stopping data transmission to executing data transmission. The ratio of the deep sleep mode is higher than the ratio of the shallow sleep mode, which means in the same period of time, the deep sleep mode stops data transmission for more time than the shallow sleep mode. Therefore, the power saved by the deep sleep mode is more than the power saved by the shallow sleep mode during the same time.

Additionally, by the concept of the ratio difference of stopping data transmission to executing data transmission, the present invention further provides a plurality of sleep modes 1˜N. Periods of each sleep modes 1˜N can be predefined in the user inactivity timer and the ratio of stopping data transmission to executing data transmission increases over the sleep modes 1˜N. For example, sleep mode 2 starts after sleep mode 1 and the ratio of sleep mode 2 is higher than the ration of sleep mode 1; sleep mode 3 starts after sleep mode 2 and the ratio of sleep mode 3 is higher than the ratio of sleep mode 2; and so on.

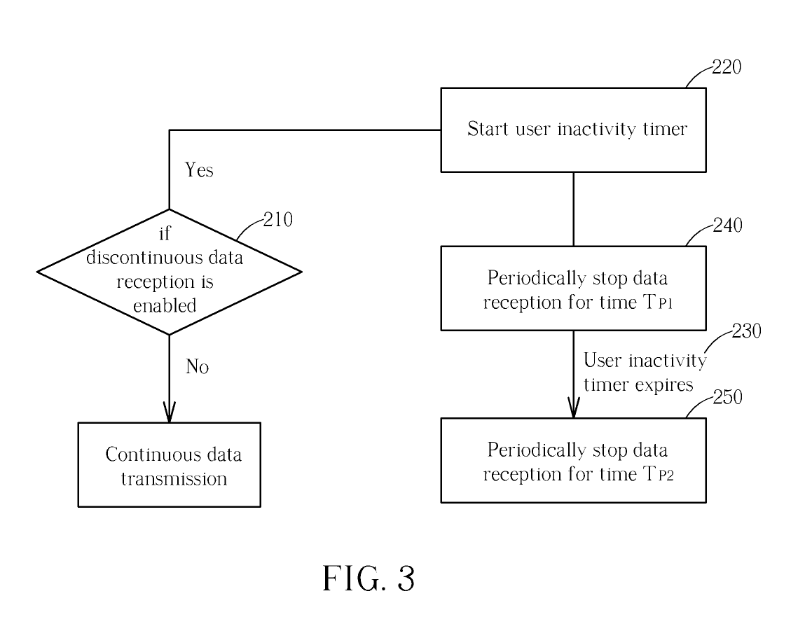

Please refer to FIG. 3. FIG. 3 is a flowchart illustrating a power-saving process 20 for a mobile communication device. The process 20 may be compiled into the program code 314 and include the following steps:

Step 210: Determine if discontinuous data reception is enabled; if so, go to step 220; if not, execute continuous data reception.

Step 220: Start a user inactivity timer for entering a shallow sleep mode.

Step 230: When the user inactivity timer expires, enter a deep sleep mode.

Step 240: Periodically stop data reception for a first predetermined time T_{P1} in the shallow sleep mode.

Step 250: Periodically stop data reception for a second predetermined time T_{P2} in the deep sleep mode.

Step 260: Resume continuous data reception when a condition is met.

Steps 210˜260 are similar to steps 110˜160 and the related description is omitted for brevity. The difference between the power-saving processes 10 and 20 is that the power-saving process 10 is for transmitting, while the power-saving process 20 is for receiving. Besides, the power-saving processes 10 and 20 can be both applied on the mobile communication device.

To sum up, the present invention provides a method for saving power of the mobile communication device. The method utilizes discontinuous data transmission/reception to save power in the sleep mode so as to extend use-time of the mobile communication device, providing great convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power-saving method for a mobile communication device, comprising:
executing discontinuous data transmission when the mobile communication device enters a standby mode.

2. The method of claim 1, wherein executing discontinuous data transmission when the mobile communication device enters the standby mode comprises periodically stopping the mobile communication device transmitting data when the mobile communication device enters the standby mode.

3. The method of claim 2, wherein periodically stopping the mobile communication device transmitting data when the mobile communication device enters the standby mode comprises:
periodically stopping the mobile communication device transmitting data by a first ratio for a first predetermined time; and
periodically stopping the mobile communication device transmitting data by a second ratio after the first predetermined time;
wherein the first and the second ratios represent a period of stopping data transmitting and a period of executing data transmitting, and the second ratio is higher than the first ratio.

4. The method of claim 1, further comprising the mobile communication device exiting the standby mode when a condition is met.

5. A power-saving method for a mobile communication device, comprising:
executing discontinuous data reception when the mobile communication device enters a standby mode.

6. The method of claim 5, wherein executing discontinuous data reception when the mobile communication device enters the standby mode comprises periodically stopping the mobile communication device receiving data when the mobile communication device enters the standby mode.

7. The method of claim 6, wherein periodically stopping the mobile communication device receiving data when the mobile communication device enters the standby mode comprises:
periodically stopping the mobile communication device receiving data by a first ratio for a first predetermined time; and
periodically stopping the mobile communication device receiving data by a second ratio after the first predetermined time;
wherein the first and the second ratios represent a period of stopping data receiving and a period of executing data receiving, and the second ratio is higher than the first ratio.

8. The method of claim 5, further comprising the mobile communication device exiting the standby mode when a condition is met.

9. A mobile communication device with power-saving function comprising:
means for executing discontinuous data transmission when the mobile communication device enters a standby mode.

10. The mobile communication device of claim 9, wherein the means for executing discontinuous data transmission when the mobile communication device enters the standby mode comprises means for periodically stopping the mobile communication device transmitting data when the mobile communication device enters the standby mode.

11. The mobile communication device of claim 10, wherein the means for periodically stopping the mobile communication device transmitting data when the mobile communication device enters the standby mode comprises:
means for periodically stopping the mobile communication device transmitting data by a first ratio for a first predetermined time;
means for periodically stopping the mobile communication device transmitting data by a second ratio after the first predetermined time;
wherein the first and the second ratios represent a period of stopping data transmitting and a period of executing data transmitting, and the second ratio is higher than the first ratio.

12. The mobile communication device of claim 9, further comprising means for the mobile communication device exiting the standby mode when a condition is met.
